(19) United States
(12) Patent Application Publication
(10) Pub. No.: US 2025/0128914 A1
(43) Pub. Date: Apr. 24, 2025

(54) APPARATUS FOR MEASURING A FORCE ON AN ELEVATOR INSTALLATION, METHOD FOR CHECKING BALANCING OF AN ELEVATOR INSTALLATION, AND AN ELEVATOR INSTALLATION FOR IMPLEMENTING THE METHOD

(71) Applicant: Inventio AG, Hergiswil (CH)

(72) Inventors: Romeo Lo Jacono, Gravesano (CH); Gilles Trottman, Meierskappel (CH); Alessandro D'Apice, Ebikon (CH); Amit Pratihar, Pune Maharashtra (IN)

(21) Appl. No.: 18/719,300

(22) PCT Filed: Dec. 19, 2022
(86) PCT No.: PCT/EP2022/086537

§ 371 Date: Jun. 13, 2024

(30) Foreign Application Priority Data
Dec. 20, 2021 (EP) 21215984.2

(51) Int. Cl. B66B 5/00; B66B 1/34

(52) U.S. Cl. CPC B66B 5/0037; B66B 1/3476

(57) ABSTRACT

An apparatus for an elevator installation includes a blocking mechanism and a measuring mechanism, wherein the blocking mechanism is adapted to connect a counterweight and/or a car of the elevator installation to a rail system of the elevator installation, and wherein the measuring mechanism is adapted to map a force transferred from the counterweight and/or car into the rail system as a force value for checking a balance of the elevator installation.

### FIELD

The present invention relates to an apparatus for an elevator installation, a method for checking the balancing of an elevator installation, and an elevator installation.

### BACKGROUND

An elevator installation has vertically movable components such as a car and at least one counterweight. The movable components are connected to each other via at least one suspension means. The suspension means runs over at least one drive roller of a drive sheave of the elevator installation. The suspension means carries a constant weight of the counterweight on one side of the drive sheave. On the other side, the suspension means carries the variable weight of the car and a load to be transported in the car. The drive unit applies a torque to compensate for a difference between the weights. The torque is transmitted to the suspension means by the friction or traction between the suspension means and the drive sheave.

The functionalities of the elevator installation must be checked prior to its commissioning and/or as part of maintenance work. In particular, the balancing of the elevator installation, i.e., the weight ratio between the car and the counterweight(s), can be checked.

WO2008071301A1 describes a method and an apparatus for testing elevator installations.

WO2013068648A1 describes a method and an apparatus for measuring a balance of an elevator and a method for balancing the elevator.

WO2021084012A1 discloses a car brake of an elevator installation.

DE4311011A1 describes a method and an apparatus for testing an elevator.

### SUMMARY

Among other things, there may be a need for an improved apparatus and a simplified method for checking the balancing of an elevator installation. Further, there may also be a need for an elevator installation in which a simplified method for checking the balance of an elevator installation can be performed.

Such a need may be met by an apparatus, a method for checking the balancing of an elevator installation, as well as an elevator installation according to the advantageous embodiments defined and described in the description.

The approach presented herein the check for balancing is simplified and checked without additional weight, traditionally used to change the tensile force between the drive sheave and the car, for example, by means of lead blocks. Instead of using the known additional weight in the car, one of the movable components is temporarily fixed, for example, to a rail system of the elevator installation and a tensile force in the suspension means is changed. The tensile force may also be reduced other than by the additional weight. During this process, a force resulting from the changed tensile force is measured at the fixed component.

The measured force can be used to determine the weight of the counterweight and/or car and thus the balancing of the elevator installation.

By measuring the force acting on the fixed component, there is no need to provide and remove the additional weight or to load and unload the car with the additional weight. All that is required to measure the force is at least an easily transportable apparatus presented herein that has a blocking mechanism and a measuring mechanism.

According to a first aspect of the invention, an apparatus for an elevator installation is presented, wherein the apparatus has a blocking mechanism and a measuring mechanism, wherein the blocking mechanism is configured to connect (fasten) a movable component of the elevator installation to a rail system of the elevator installation and/or to support it on the rail system, wherein the measuring mechanism is configured to map a force transferred from the movable component into the rail system as a force value.

According to a second aspect of the invention, a method for checking the balancing of an elevator installation is presented, wherein the elevator installation comprises at least one elevator controller, a guide rail and at least one counterweight and a car, wherein the at least one counterweight is connected to the car via at least one suspension means, the method comprising the steps of:
connecting at least one apparatus according to one aspect of the invention to the at least one guide rail;
placing the at least one counterweight and/or the car onto the at least one apparatus;
changing a tensile force transmitted to the at least one counterweight and/or the car via suspension means;
recording a force value on the basis of a force transferred to the rail system via the apparatus.

According to a third aspect of the invention, an elevator installation with at least one, preferably two, counterweight(s), a car and an elevator controller is presented, wherein the elevator controller is configured to connect to an apparatus according to a first aspect of the invention and to carry out a method according to a second aspect of the invention.

A blocking mechanism may essentially completely prevent a movement of the at least one counterweight and/or the car along the guide rail, at least in one direction. The direction may, in particular, be a vertical direction. In this direction, the blocking mechanism may present an insurmountable obstacle for the movable component (at least one counterweight and/or of the car). The blocking mechanism may transfer compressive forces and/or tensile forces exerted by the movable component into the rail system.

The blocking mechanism may have at least one hook to be inserted into a corresponding recess in the rail system. The hook may be inserted into the recess and moved along the recess until a contact surface of the hook rests against an edge of the recess. The force may be transferred into the rail system via the hook. The hook may allow for mounting and dismounting the apparatus without tools. The rail system may have several matching recesses. The apparatus may thus be attached at different positions of the rail system. The blocking mechanism may, in particular, have multiple hooks of the same type. Multiple hooks may be used to achieve redundancy and increase the operational reliability of the apparatus. Also, multiple hooks allow for a greater force to be transferred into the rail system.

The at least one hook may be designed to be symmetrical. The hook may thus be inserted into the recess in opposite orientations. Alternatively or additionally, the symmetrical hook may transfer tensile forces of the suspension means upward and the weight of the movable component downward into the rail system. When the direction of force is changed, the hook may slide in the recess until the opposite side of the hook abuts the opposite side of the recess. This allows the apparatus to be supported upward and downward on the rail system.

The blocking mechanism may have a car side and a counterweight side for connecting to the rail system. The measuring mechanism may be used on a car of the elevator installation if the car side is connected to the rail system. Alternatively, the measuring mechanism may be used on a counterweight of the elevator installation if the counterweight side is connected to the rail system. A car guide of the rail system may differ from a counterweight guide of the rail system. The car side may be adapted to the car guide. The counterweight side may be adapted to the counterweight guide. The car side and the counterweight side may be connected to the rail system on different sides of the rail system.

Alternatively or additionally, according to one embodiment, the apparatus may be connected to the counterweight and/or car by means of a screwing apparatus.

Alternatively or additionally, the apparatus comprises a screwing apparatus with which a tensile force transmitted to the at least one counterweight and/or the car via suspension means may be changed in the mounted state.

According to one embodiment, the screwing apparatus has a thread, preferably a threaded rod, via which the counterweight and/or car may be moved a defined distance in order to change the tensile force. Preferably, the counterweight and/or car may be lifted via the screwing apparatus in order to reduce the tensile force. Preferably, the counterweight and/or car may alternatively or additionally be pushed downward or pulled downward by the screwing apparatus in order to increase the tensile force.

The measuring mechanism may be configured such that the force value may be transmitted in the form of a signal to a controller of the elevator installation. That way, the apparatus may be connected to the elevator controller. This allows for at least partial automation of the methods in which the measuring mechanism of the apparatus is used. This may be implemented, for example, by means of a cable connection and/or a wireless connection.

The apparatus may be configured such as to further comprise a display for showing the force values measured by the measuring mechanism. Thus, when using the apparatus for measuring tensile forces, the force value set and displayed accordingly in a static state may be read and used, for example, by entering it at the elevator controller.

An elevator installation can be a passenger transport system. The elevator installation can have at least one counterweight per car. The elevator installation may, in particular, have two counterweights per car. At least one suspension means is arranged between the car and the counterweights. The suspension means may be a cable or a belt, for example. The suspension means may be guided over at least one drive sheave of a drive unit of the elevator installation. The drive sheave may be arranged at an upper end of a rail system of the elevator installation. The counterweights may be moved in the opposite direction to the car.

The rail system may have at least one guide per car and at least one guide per counterweight. The rail system may, in particular, have two parallel running, vertical guide rails between which the car is mounted so as to be vertically movable. Each guide rail may have a guide for one of the counterweights on an outer side.

The apparatus may be temporarily connected to the rail system. The apparatus may also be connected to another static element, such as a bracket or shaft wall. The apparatus may be mechanically connected to the rail system. For example, the apparatus may be bolted to the guide rail or clamped to the guide rail. In case of two guide rails, the apparatuses may be used in pairs. The guide rail may have at least one predefined attachment point for the apparatus, at which the device may be positively connected to the guide rail. The device may be connected to the car in the immediate vicinity of a car brake of the elevator installation. This means that the force measured by the measuring mechanism may correspond more precisely to the actual force at the load sensor, which is integrated into the car brake. The apparatus may be arranged above or below the movable component.

A measuring mechanism may be a load cell or a weighing beam, for example. The measuring mechanism may be arranged between an interface of the apparatus and the rail system and an interface of the apparatus and the movable component. An acting force may deform the measuring mechanism slightly elastically. The deformation may be mapped as an electrical signal. The signal may represent the force. The measuring mechanism may be calibrated. For example, the measuring mechanism may be set to zero before the movable component is fixed.

The tensile force may be increased or reduced.

The tensile force may be changed by using a screwing apparatus of the apparatus. The screwing apparatus may have a thread via which the movable component may be moved a defined distance in order to change the tensile force. The component may be lifted using the screwing apparatus in order to reduce the tensile force. The component may also be pushed downward or pulled downward by the screwing apparatus in order to increase the tensile force.

Alternatively or additionally, the tensile force may be changed via a torque of the drive unit provided by the traction sheave. The torque may be changed via a motor controller of the drive unit. The torque may also be changed by a brake on the traction sheave. A magnitude of change may be specified to the motor controller unit and/or an actual change in torque may be measured and output by the motor controller unit.

The component may be mechanically connected to the apparatus connected to the rail system. The apparatus may be connected to the rail system below the movable component and may be connected to the movable component from below. The mechanical connection allows for the tensile force of the suspension means to be increased without the component lifting off the apparatus. The apparatus may also be connected to the rail system above the movable component and may be mechanically connected to the movable component from above. The movable component may then be suspended from the apparatus and the suspension means may be relieved. The component may also be pushed downward by the apparatus. Work on the elevator may also be carried out safely as a result of the mechanical fixation.

In a first step of the method, the weight of the at least one counterweight and/or the car can be checked. A service technician can count the number of counterweight elements (e.g., concrete elements). In an elevator installation with two counterweights, the service technician can ensure that both counterweights weigh the same. For example, they can count the number of counterweight elements of the first counterweight and the counterweight elements of the second counterweight and compare the number of counterweight elements. If the number of counterweight elements is the same, it can be assumed that the counterweights are of equal weight, i.e., the system is balanced.

The test carried out can be confirmed in a further method step of the elevator controller. In particular, the confirmation can be confirmed via an input in a mobile device connected to the elevator controller. In an elevator installation with only one counterweight, the service technician can, for example, enter the weight of the counterweight (number of counterweight elements) or confirm a set value displayed by the mobile device by making a corresponding entry in a mobile device connected to the elevator controller. In an elevator installation with two counterweights, for example, the service technician can confirm the balance of the counterweights by making a corresponding entry in a mobile device connected to the elevator controller. The elevator control system thus knows the actual counterweight or balancing of the elevator installation.

Once the component has been placed on the service apparatus a brake on the elevator installation can be activated. The drive unit can then be switched torque-free. The brake can then be released to change the tractive force. After setting a static state, the force value can be determined. The force value can be compared with a reference value. The unloaded or empty car can be lighter than the counterweight or counterweights. A ratio between a mass of the car and a mass of the counterweights can be referred to as the balance of the elevator installation. For example, the balance can be 4/6, in which case the mass of the car is approx. 66% of the mass of the counterweight. In particular, the counterweight or both counterweights can be placed on the service apparatus to check the balance. When the counterweight is positioned, the drive unit compensates for the difference in weight between the counterweight and the car by applying torque to the drive sheave. The brake is located on the car and blocks movements of the elevator installation so that after the drive unit has been switched torque-free, the entire suspension means is loaded by the weight of the counterweight. The force sensor can now be zeroed and the brake can be released. When the brake is released, only the weight of the car is held by the suspension means, as the difference in weight between the counterweight and the car is held by the service apparatus and is reflected in the force value. In the case of two counterweights, each of the counterweights can be connected to the apparatus/two apparatuses and measured using the procedure described. If it was determined in the step described above that the two counterweights are of equal weight (e.g., by counting the counterweight elements in each of the two counterweights), it may be sufficient to carry out the steps described for one of the two counterweights. The total weight of the counterweights can then be deduced from the knowledge of the identical weight. The balance of the elevator installation can be checked by comparing the determined total weight of the counterweight with a reference value.

The reference value can be determined depending on a balancing factor of the elevator installation and a car target weight. In particular, a reference range can be determined, which corresponds to a tolerance range around the reference value. The reference value can, for example, be calculated from a car weight and a balancing factor (both depending on the type of the elevator installation). For example, the nominal car weight (empty car) may be 610 kg and the balancing factor may be 4/6, resulting in a total weight for the counterweight of (610/4*6=) 915 kg. The apparatus should therefore measure a force value on a counterweight which corresponds to a weight of (915/2) 457.5 kg. In order to assess the balancing of the elevator installation, a tolerance range around the reference value can be determined in which the elevator installation is considered to be balanced. For example, a tolerance range of +/−10% can be selected. In this case, the elevator installation is considered balanced if the force value measured corresponds to a weight of (+/−10% of 457.5) 411.75 to 503.25 kg.

The apparatus can be connected to the elevator controller using communication technology. At least one, preferably all, of the method steps from the list can be carried out by the elevator controller: placing at least one counterweight and/or the car, changing a tensile force transmitted to the counterweight and/or the car via the suspension means, mapping a force value, activating the brake, deactivating the brake, switching the drive unit without torque and/or comparing. This allows the balancing check procedure to be at least partially automated. For example, this can be started by a service technician after the device has been attached to the rail system by entering data into a mobile device that is connected to the elevator installation (i.e., the elevator controller). The elevator controller can then carry out the above steps one after the other. In this way, the apparatus can detect when the counterweight touches down using the measuring apparatus and communicate this detection to the elevator controller. The elevator controller can then initiate the next steps. In the next step, the brake can be activated by the elevator controller. After the elevator controller detects that the brake has been applied (e.g., by a sensor on the brake), the elevator control can switch the drive apparatus without torque. As soon as a torqueless state is detected (e.g., by a current measurement in the inverter of the elevator drive), the elevator controller can monitor the force value on the apparatus and wait for a static state, wherein a force value is resisted when the static state is reached and the elevator controller evaluates this. This means that the method can be automated and carried out with only minimal manual steps by a service technician.

A load sensor may also be designed as a load cell or weighing beam. The load sensor may be arranged at an interface between the suspension means and the car. The load sensor may be integrated in a braking mechanism of the car. The car may also have several load sensors.

A load value measured by the load sensor may be compared with a known value in order to calibrate the load sensor. If the load value deviates from the known value, a correction factor may be determined and the load value may be corrected using the correction factor.

It should be noted that some of the possible features and advantages of the invention are described herein with reference to different embodiments of methods on the one hand and of apparatuses on the other. A person skilled in the art will recognize that the features can be suitably combined, adapted, or exchanged in order to arrive at further embodiments of the invention.

Embodiments of the invention will be described below with reference to the accompanying drawings, wherein neither the drawings nor the description are intended to be interpreted as limiting the invention.

### DESCRIPTION OF THE DRAWINGS

FIGS. 1a and 1b show representations of an apparatus according to an exemplary embodiment; and

FIG. 2 shows a weight measurement according to one embodiment of the invention.

The drawings are merely schematic, and not to scale. The same reference signs indicate the same or equivalent features.

### DETAILED DESCRIPTION

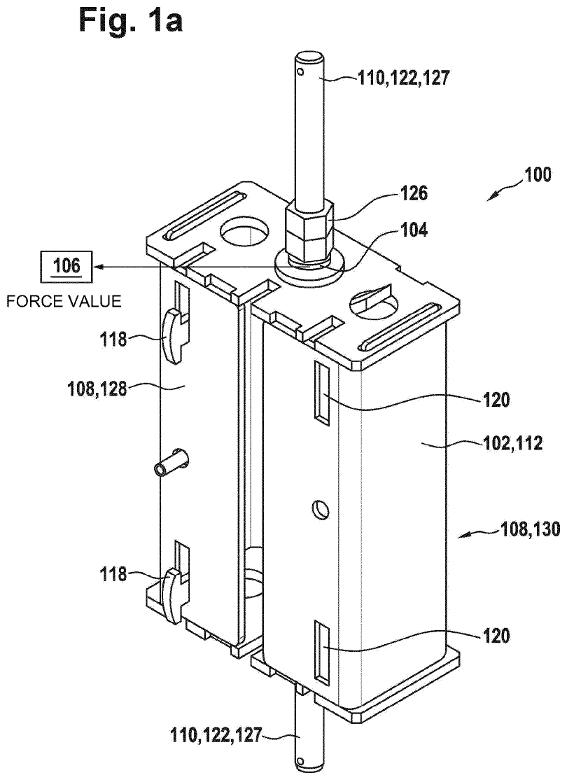

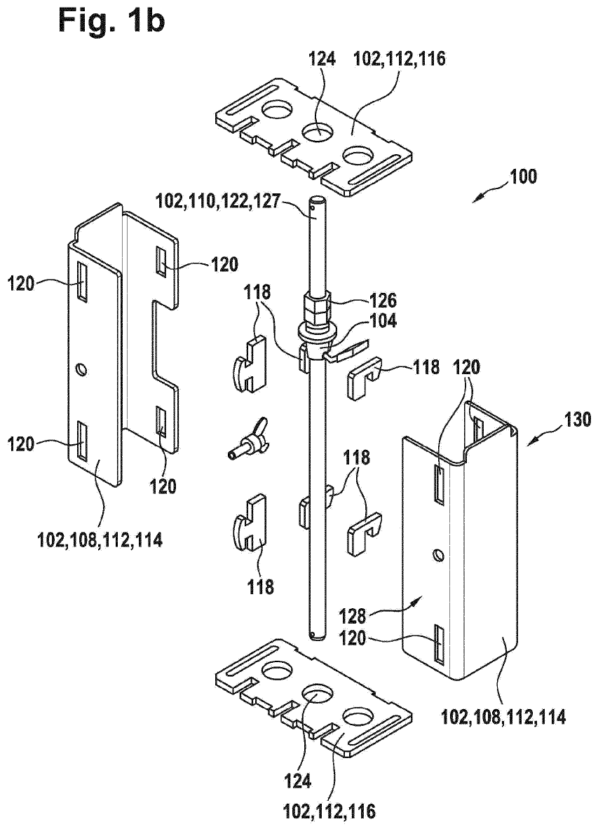

FIG. 1a shows a perspective representation of an apparatus 100 according to an exemplary embodiment. FIG. 1b shows an exploded view of the apparatus 100.

The apparatus 100 comprises a blocking mechanism 102 and a measuring mechanism 104. The blocking mechanism 102 is configured to be mechanically connected to a rail system of an elevator installation and to support, on the rail system, a component of the elevator installation that is movably mounted on the rail system, for example a car or a counterweight, or to fasten it to the rail system and to transfer a force from the movable component into the rail system. The measuring mechanism 104 is configured to map the force transferred from the movable component via the blocking mechanism 102 into the rail system as a force value 106.

The blocking mechanism 102 has at least one rail interface 108 for connecting to the rail system and at least one component interface 110 for connecting to the component. The measuring mechanism 104 is arranged between the rail interface 108 and the component interface 110.

The apparatus 100 has a substantially cuboid housing 112 composed of stamped and bent parts. The housing 112 has two side parts 114 and two covers 116. The side parts 114 are bent in a U-shape and are each connected to one of the covers 116 at opposite end faces. The side parts 114 and the covers 116 enclose an interior of the apparatus 100. The side parts 114 and the covers 116 are made of metal.

The rail interface 108 has hooks 118 to be inserted into corresponding recesses in the rail system. The hooks 118 are designed as stamped parts made from a sheet material. The hooks 118 are also made of metal. The hooks 118 protrude from slots 120 in the side parts 114 and may be inserted into corresponding elongate recesses in the rail system. After insertion, the hooks 118 may be moved along the recess until they engage around an edge of the respective recess in the rail system and fix the apparatus 100 at the edge.

The component interface 110 has a threaded rod 122. The threaded rod 122 is made of metal. The threaded rod 122 runs through the interior and through one hole 124 per cover 116. At least two nuts 126 are screwed onto the threaded rod 122. The threaded rod 122 is supported on at least one of the covers 116 by the nuts 126. A length of the threaded rod 122 protruding from the housing 112 may be varied. Depending on the application, different lengths of threaded rod 122 may be set.

The measuring mechanism 104 is arranged on the threaded rod 122 between the nuts 126 and the cover 116.

The length of the threaded rod 122 may also be changed once the component is arranged on the apparatus 100. The threaded rod 122 may then be referred to as a screwing apparatus 127. The component may be moved a certain distance by changing the length. While the component is being moved, a tensile force or compressive force is exerted on the component, which may be mapped by the measuring mechanism 104 as the force value 106.

Alternatively or additionally, the threaded rod 122 may also be screwed into a thread of the component. When used as a screwing apparatus 127, the threaded rod 122 may be rotated in the thread of the component to move the component by the distance and apply the force to the component.

In one exemplary embodiment, the blocking mechanism 102 has two rail interfaces 108. The two rail interfaces 108 are arranged on opposite sides of the housing 112. One rail interface 108 is configured as a car side 128. The other rail interface 108 is configured as a counterweight side 130. When the car side 128 is connected to the rail system, the component interface 110 may be connected to the car of the elevator installation. When the counterweight side 130 is connected to the rail system, the component interface 110 may be connected to the counterweight of the elevator installation.

In one exemplary embodiment, the hooks 118 on the car side 128 are designed as symmetrical double hooks. The double hooks may thus transfer forces, which act on the blocking mechanism 102 from opposite directions, into the rail system.

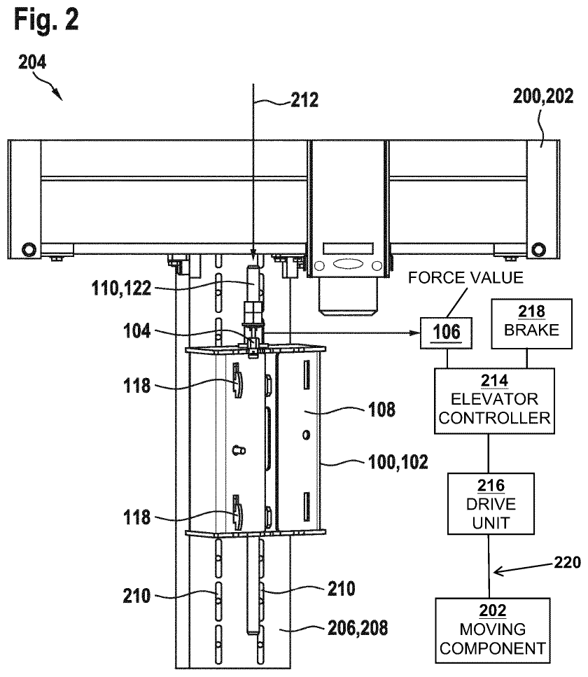

In one exemplary embodiment (not shown), the apparatus 100 has an interface for establishing a communication connection between the apparatus 100 and an elevator controller 214 (see FIG. 2). This interface may be designed as a wireless connection or as a wired connection, for example. In another exemplary embodiment, the apparatus 100 has a display for displaying the measured values measured by the measuring mechanism 104. In yet another alternative embodiment, the measured values are transmitted wirelessly to a display unit in order to be displayed. The display unit may be configured as a smartphone.

FIG. 2 shows a weight measurement according to one embodiment of the invention. Weight measurement is carried out using a service apparatus 100 according to the approach presented herein. The service apparatus 100 substantially corresponds to the service apparatus of FIGS. 1a and 1b. The weight measurement is shown here on a counterweight 200 as the moving component 202 of an elevator installation 204, but can also be carried out analogously on a car of the elevator installation 204.

For the weight measurement, the blocking mechanism 102 of the service apparatus 100 is mechanically connected to a rail 206 of a rail system 208 of the elevator installation 204. For this purpose, the hooks 118 of the counterweight side of the rail interface 108 of the blocking mechanism 102 are inserted into recesses 210 of the rail 206. The blocking mechanism 102 thus blocks a travel path of the counterweight 200 along the rail 206. The measuring apparatus 104 is arranged on a top side of the service apparatus 100.

For measuring, the counterweight 200 is slowly placed on the threaded rod 122 of the component interface 110 by a drive unit 216 of the elevator installation 204 by raising the elevator car. When touching down, at least a portion of a weight 212 of the counterweight 200 is transferred into the rail system 208 via the service apparatus 100. The proportion can become so large that a static equilibrium is established between a weight force of the car and the remainder of the weight force 212 of the counterweight 200. The proportion of the weight 212 can then be measured by the measuring device 104.

The counterweight 200 can also only be lowered so far that the component interface 110 and the counterweight 200 are just touching. A brake 218 of the elevator installation 204 can then be activated and the drive unit 216 can be switched torque-free. After the brake is released, the static equilibrium is established by the counterweight 200 settling until the excess weight of the counterweight 200 is discharged into the rail system 208 via the service apparatus 100 and detected by the measuring apparatus 104. This allows the weight difference between the counterweight(s) and the car (also known as balancing) selected for the elevator installation to be measured.

Once the counterweight 200 is in place, the drive unit can continue to raise the car until a suspension means 220 between the drive unit 216 and the counterweight 200 is released. When slackening, the tensile force of the suspension means is reduced to approximately zero. The weight 212 of the counterweight 200 is now approximately completely transferred from the blocking device 102 to the rail 206. The measuring device 104 can then map the full weight 212 in the force value 106.

After measuring, the suspension means is tensioned by the drive unit by lowering the car again and increasing the tensile force in the suspension means until the counterweight 200 lifts off the component interface 110 again. The service apparatus 100 is then removed from the rail 206. The measuring process can now be repeated on the other counterweight of the car.

The measuring mechanism may also be removed from the apparatus and the blocking mechanism may be used without the measuring mechanism as a safety mechanism for fixing one of the movable components. For example, maintenance work on the elevator installation may be carried out safely.

Finally, it should be noted that terms such as “comprising,” “having,” etc., do not exclude other elements or steps, and terms such as “a” or “an” do not exclude a plurality. Furthermore, it should be noted that features or steps which have been described with reference to one of the above exemplary embodiments may also be used in combination with other features or steps of other exemplary embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. An apparatus for checking a balancing of moving components connected to a suspension means in an elevator installation, the apparatus comprising:
a blocking mechanism adapted to connect to a rail system of the elevator installation;
a measuring mechanism arranged at the blocking mechanism; and
wherein, when the blocking mechanism is connected to the rail system and one of the moving components of the elevator installation is connected to and/or supported on the blocking mechanism, the measuring mechanism maps a force transferred from the one moving component into the rail system as a force value.

17. The apparatus according to claim 16 wherein the blocking mechanism includes a hook adapted to be inserted into a corresponding recess in the rail system to connect the blocking mechanism to the rail system.

18. The apparatus according to claim 17 wherein the hook has a symmetrical shape enabling the hook to be inserted into the recess in opposite orientations.

19. The apparatus according to claim 16 wherein the moving components include an elevator car and a counterweight, the blocking mechanism having a car side and a counterweight side, when the car side is connected to the rail system and the elevator car is connected to and/or supported by the blocking mechanism the measuring mechanism maps the force transferred from the elevator car, and when the counterweight side is connected to the rail system and the counterweight is connected to and/or supported by the blocking mechanism the measuring mechanism maps the force transferred from the counterweight.

20. The apparatus according to claim 16 wherein the measuring mechanism maps the force as an electrical signal representing the force value and adapted for transmission to an elevator controller of the elevator installation.

21. The apparatus according to claim 16 including a screwing apparatus extending from the blocking mechanism, the screwing apparatus adapted to contact and move the one moving component a defined distance to change a tensile force transmitted via the suspension means of the elevator installation to the one moving component.

22. The apparatus according to claim 21 wherein the screwing apparatus includes a threaded rod for changing a length of the screwing apparatus extending from the blocking mechanism to move the one moving component.

23. The apparatus according to claim 22 wherein the tensile force is reduced when the one moving component is lifted by the screwing apparatus and the tensile force is increased when the one moving component is moved downward by the screwing apparatus.

24. A method for checking a balancing of an elevator installation, the elevator installation including a rail guiding a moving component connected to a suspension means, the method comprising the steps of:
connecting the apparatus according to claim 16 to the rail;
placing the moving component onto the blocking mechanism of the apparatus;
changing a tensile force transmitted to the moving component by the suspension means of the elevator installation; and
recording a force value by the measuring mechanism based on a force transferred to the rail system by the apparatus.

25. The method according to claim 24 wherein the moving component is an elevator car or a counterweight.

26. The method according to claim 24 including changing the tensile force using a screwing apparatus included in the apparatus and/or using a drive unit of the elevator installation.

27. The method according to claim 24 including mechanically connecting the moving component to the apparatus.

28. The method according to claim 24 including a first step of checking a weight of the moving component.

29. The method according to claim 28 including confirming that the first step has been carried out by entering an input in a mobile device adapted to be connected to an elevator controller of the elevator installation.

30. The method according to claim 24 including, after the moving component has been placed on the blocking mechanism of the apparatus, activating a brake of the elevator installation and switching a drive unit of the elevator installation torque-free, then releasing the brake to change a tractive force and, after a static state has been set, detecting the force value and comparing the force value with a predetermined reference value.

31. The method according to claim 30 including determining the reference value as a function of a balancing factor of the elevator installation and a desired elevator car weight.

32. The method according to claim 31 including determining a reference range corresponding to a tolerance range around the reference value.

33. The method according to claim 30 including establishing communication between the apparatus and an elevator controller of the elevator installation, and operating the elevator controller to perform the method steps after the apparatus is connected to the rail.

34. A elevator installation comprising:
at least one counterweight;
a car connected to the at least one counterweight by a suspension means; and
an elevator controller adapted to perform the method according to claim 24.
